(19) United States
(12) Patent Application Publication
(10) Pub. No.: US 2026/0344639 A1
(43) Pub. Date: Nov. 5, 2026

(54) DETECTION AND IDENTIFICATION SYSTEM

(71) Applicant: Interdisciplinary Consulting Corporation, Gainesville, FL (US)

(72) Inventors: William C. Patterson, Gainesville, FL (US); Daniel D'Andrea, Gainesville, FL (US); Jason Johnson, Gainesville, FL (US)

(21) Appl. No.: 19/663,770

(22) Filed: Apr. 30, 2026

Related U.S. Application Data
(60) Provisional application No. 63/798,177, filed on May 1, 2025.

(51) Int. Cl. A01M 1/02

(52) U.S. Cl. CPC A01M 1/026

(57) ABSTRACT

A detection and identification system includes: a processor; and a storage device, wherein the storage device includes: a wavelet filter library, wherein the wavelet filter library includes at least one filter family corresponding to a particular entity; and instructions stored in the storage device that when executed by the processor, direct the system to: receive sensor data; apply the filter family from the wavelet filter library to the sensor data; for each application of the filter family to the sensor data that satisfies a matching condition of the filter family, generate an indication of an existence of the particular entity corresponding to that filter family; and output the indication of the existence of the particular entity.

### CROSS-REFERENCE TO RELATED APPLICATIONS

This application claims the benefit of priority to U.S. Provisional Patent Application No. 63/798,177, filed on May 1, 2025, the contents of which are incorporated by reference herein in its entirety.

### GOVERNMENT SUPPORT

This invention was made with Government support under Contract No. 2024-51402-41936 awarded by the United States Department of Agriculture. The Government has certain rights in the invention.

### BACKGROUND

Pest management often requires one to physically check the status of every trap and bait station. To minimize the need to physically check for pests, remote pest detection technology has been incorporated in pest management. Remote pest detection uses technology such as various sensors and data analysis to identify and track pests, such as certain animals and insects. Imaging technology, including infrared imaging, is often used for remote pest identification.

In addition to pest management, remote monitoring technology has many uses, including, but not limited to, medical, defense, infrastructure maintenance, and remote research stations. Therefore, improvements in remote monitoring technologies and alternatives to detection and identifications systems continue to be of interest.

### BRIEF SUMMARY

Systems and methods for detecting and identifying an entity (e.g., insect) by applying at least one wavelet filter to sensor data are provided.

A detection and identification system as described herein includes: a processor; and a storage device, wherein the storage device includes: a wavelet filter library, wherein the wavelet filter library includes at least one filter family corresponding to a particular entity; and instructions stored in the storage device that when executed by the processor, direct the system to: receive sensor data; apply the filter family from the wavelet filter library to the sensor data; for each application of the filter family to the sensor data that satisfies a matching condition of the filter family, generate an indication of an existence of the particular entity corresponding to that filter family; and output the indication of the existence of the particular entity.

In some aspects, the techniques described herein relate to a method, including: receiving sensor data; applying a filter family to the sensor data; for each application of the filter family to the sensor data that satisfies a matching condition of the filter family, generating an indication of an existence of a particular entity corresponding to that filter family; and outputting the indication of the existence of the particular entity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A illustrates a sound file visualization of a grasshopper.

FIG. 1B illustrates a sound file visualization of a cricket.

FIG. 2A illustrates an example detection and identification system and FIG. 2B illustrates an example detection and identification method.

FIG. 3A illustrates an example operating environment for a detection and identification system.

FIG. 3B illustrates example system architecture for a data acquisition system.

FIG. 3C illustrates example system architecture for a sensor.

FIG. 4A illustrates a sound wave.

FIG. 4B illustrates a scalogram depicting results of conventional wavelet analysis.

FIG. 4C illustrates a scalogram depicting results of designer wavelet analysis (non-optimized).

### DETAILED DESCRIPTION

Systems and methods for detecting and identifying an entity by applying at least one wavelet filter to received sensor data are provided.

Conventionally, there are a variety of systems and methods deployed for animal/pest detection. Indeed, beyond trapping mechanisms, a variety of sensor technology (e.g., imaging sensors, motion sensors, infrared sensors, etc.) can be used for the monitoring and detection of pests. However, these existing systems and methods may be sensitive to environmental conditions, may generate false detections, and may have limited ability to distinguish among different animals based on sensed data.

Existing animal/pest detection can also employ the use of acoustic (i.e., audio) sensors. In many cases, acoustic sensors are used to detect noise level changes (e.g., detect a sound). However, acoustic sensors are often limited to detecting noise or recording audio. For example, imaging sensors (e.g., cameras) may be equipped with audio sensors to enable the camera to start recording in response to detecting sound above a certain level. Therefore, not only are these systems limited to detecting noise or recording, but they may also have limited ability to distinguish a source of the sound, may be susceptible to background noise, and may generate large amounts of data for later review.

Because animals (e.g., insects) produce unique sounds, it can be useful to detect and identify them based on corresponding signal characteristics. However, conventional acoustic sensors often lack this capability. Acoustic sensing arrangements may use settings and components selected for a particular frequency response or operating range. As a result, signals outside that range may be missed, and generic sound detection may not reliably distinguish among different entities that produce different signal patterns.

Implementations described herein may address these issues by providing a detection and identification system that applies one or more wavelet filters from a stored wavelet filter library to received sensor data. In some cases, the wavelet filters are organized into filter families associated with respective entities. Matching conditions may be evaluated based on correlations between the wavelet filters and the sensor data, including segmented sensor data and sensor data evaluated with dilation tolerance. In this manner, the system may improve automated detection and classification of entity-correlated signals from time-domain sensor data while reducing untargeted analysis across unrelated signal patterns.

In some implementations, these operations may be performed by a controller using stored instructions and a wavelet filter library to process digitized sensor data. For example, the controller may process successive windows of sensor data, apply one or more wavelet filters, evaluate matching conditions for corresponding filter families, and generate an indication associated with a detected entity. Such operations may support automated field detection based on acoustic, vibrational, electromagnetic, or other sensed signals.

A range of sounds a particular animal makes can be referred to as a vocalization range (e.g., vocalization range of insects). For example, certain species of elephants may produce sound at infrasonic levels (e.g., below 20 Hz), while certain species of bats may produce sound at ultrasonic levels (e.g., above 150 kHz). An acoustic wave is a type of wave that involves the propagation of vibrations through a material medium, such as a solid, fluid, or biological medium. Acoustic waves are characterized by variations in pressure over time or strain and can propagate through the medium in longitudinal or transverse modes. An ultrasonic wave is a type of wave with vibrations of frequencies greater than an upper limit of the audible range for humans (e.g., greater than 20 kilohertz). An infrasonic wave is a type of wave having vibrations of frequencies below a lower limit of the audible range for humans (e.g., less than 20 hertz).

A sound wave is the pattern of disturbance caused by the movement of energy traveling through a medium as it propagates away from the source of the sounds. Sound waves have a plurality of characteristics, including amplitude, frequency, time, velocity, and wavelength.

Advantageously, as described herein, because animals, and even other entities (e.g., vehicles) produce unique sound waves, which themselves have unique soundwave characteristics, it is possible to detect and identify an entity based on sound wave characteristics unique to each entity using the described systems and methods.

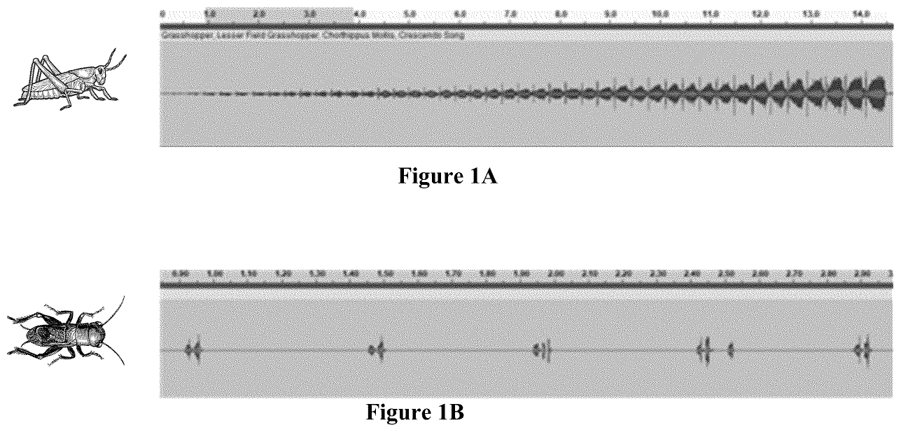

Consider the sound file visualizations depicted in FIGS. 1A-1B. FIG. 1A illustrates a sound file visualization of a grasshopper (i.e., insect, animal, pest, etc.). FIG. 1B illustrates a sound file visualization of a cricket (i.e., insect, animal, pest, etc.).

Referring to FIGS. 1A-1B, the sound waves produced by the grasshopper, as illustrated in FIG. 1A, and the sound waves produced by the cricket, as illustrated in FIG. 1B, have visually different sound wave characteristics. While this example provides for visual differences, it is notable that there are also various characteristics imperceivable to the human eye, which can be utilized for detection and identification.

Sound waves can be characterized as including one or more wavelets. A wavelet is a function that satisfies certain requirements. A wavelet is a wave-like oscillation with an amplitude that begins at zero, increases or decreases, and then returns to zero one or more times.

As described herein, it has been recognized that particular sounds can include unique wavelets and/or unique combinations of wavelets. As such, one or more wavelets can be extracted from sound wave data and categorized to indicate a particular entity. Then, the extracted wavelets (e.g., wavelet filters) can be used to identify a particular entity associated with received acoustic sensor data.

For example, with reference to FIG. 1A, the sound wave produced by the grasshopper can be considered to include one, distinct wavelet (or possibly two depending on the algorithm used to extract the wavelet), noting increasing amplification/volume in the repeating pattern of the captured sound wave data. With reference to FIG. 1B, the sound wave produced by the cricket includes three distinct wavelets.

A detection and identification system as described herein can apply wavelet filters to received sensor data to identify an entity associated with the received sensor data.

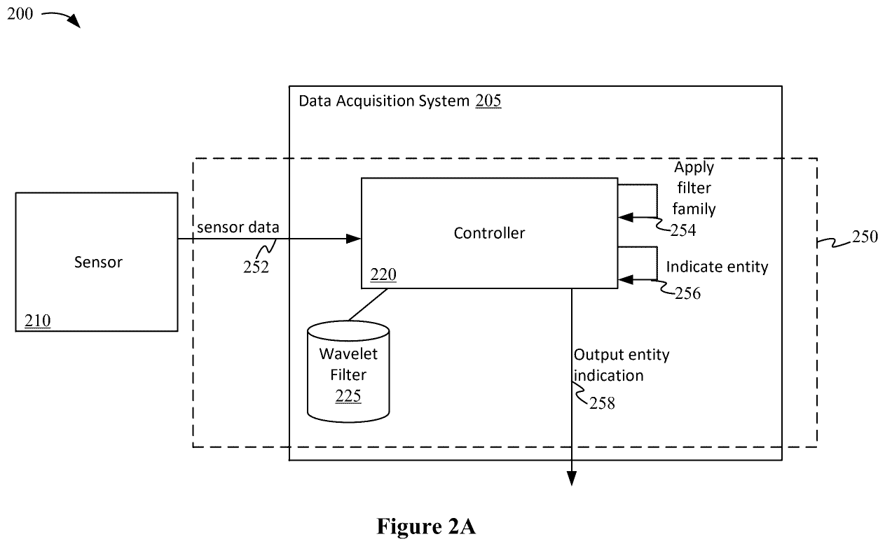

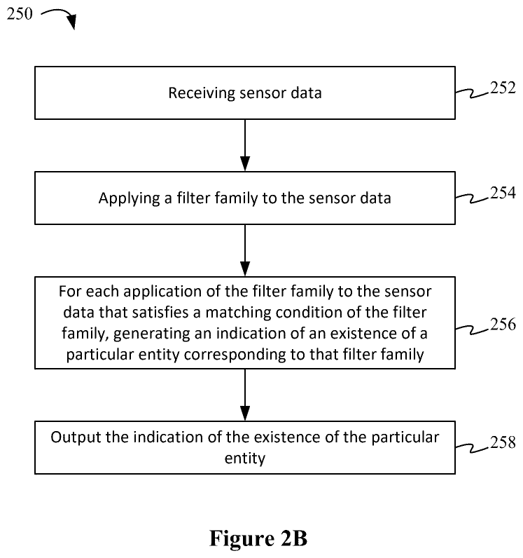

FIG. 2A illustrates an example detection and identification system and FIG. 2B illustrates an example detection and identification method.

Referring to FIGS. 2A-2B, a detection and identification system 200 can include a data acquisition (DAQ) system 205 and at least one sensor 210. The DAQ system 205 can include a controller 220 and a wavelet filter library 225. Controller 220 can be any suitable processor. Wavelet filter library 225 can be stored at a storage device of the DAQ system 205 along with instructions for performing detection and identification operations including method 250.

In some cases, the storage device of the DAQ system 205 may store the wavelet filter library 225 and executable instructions that, when executed by the controller 220, direct the DAQ system 205 to receive sensor data, apply a filter family from the wavelet filter library 225 to t he sensor data, determine whether a matching condition of the filter family is satisfied, generate an indication of an existence of a particular entity corresponding to the filter family, and output the indication.

Sensor 210 can be coupled to the DAQ system 205 via physical connection. In some cases, sensor 210 can be physically connected in a manner that enables bidirectional communication between the sensor 210 and the DAQ system 205.

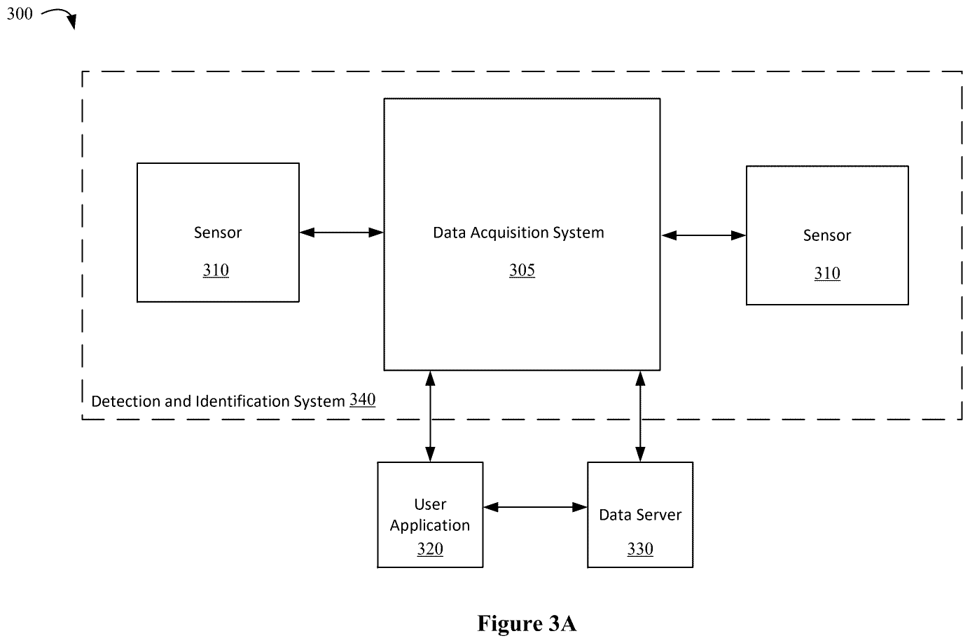

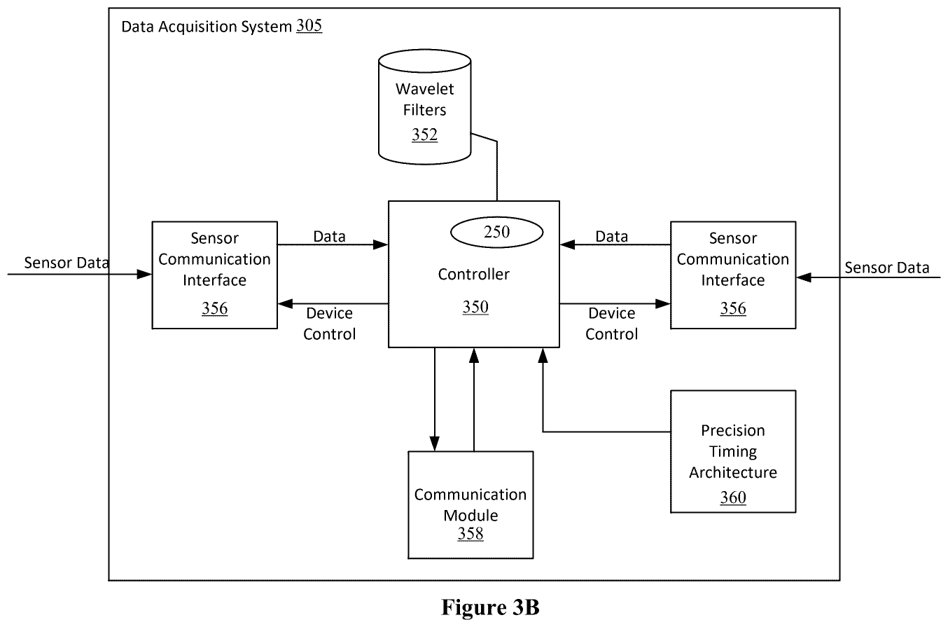

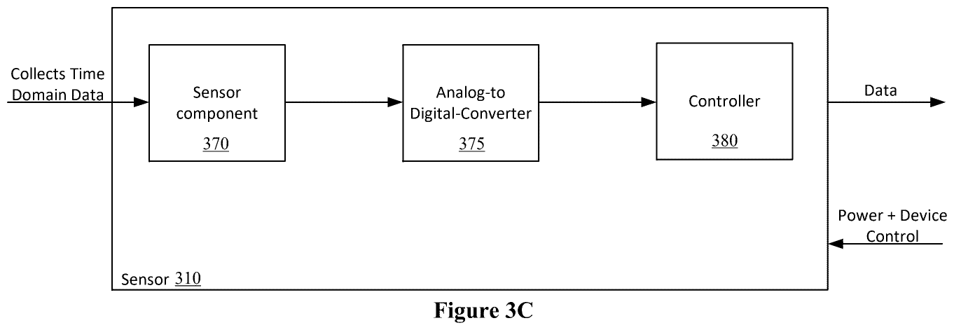

In certain implementations, the sensor 210 is or includes a microphone, for example, a microelectromechanical systems (MEMS) microphone. The sensor 210 can be located in an area where detection of certain entities is desired. For example, the sensor 210 can be placed in a crop field for detection and identification of insects. Examples of the sensor 210 and the DAQ system 205 are described in more detail with respect to FIGS. 3A-3C.

The sensor 210 can collect and send sensor data to the DAQ system 205. Upon receiving the sensor data, the controller 220 of the DAQ system 205 can perform method 250 as described with respect to FIG. 2B. In embodiments, the sensor 210 may provide sensor data to the DAQ system 205, and the controller 220 may use the received sensor data in conjunction with one or more wavelet filters from the wavelet filter library 225 to generate an entity indication output.

The wavelet filter library 225 includes at least one wavelet filter and can include one or more filter families. A filter family is a collection of one or more wavelet filters associated with a particular entity. In some cases, a filter family may include a single wavelet filter corresponding to the particular entity. In some cases, a filter family may include a plurality of different wavelet filters corresponding to the particular entity. The wavelet filter library 225 can include a plurality of filter families associated with a plurality of different entities. A wavelet filter may be extracted from a known signal associated with an entity and may be labeled to identify that entity, alone or in combination with other wavelet filters in the filter family. In some cases, a wavelet filter may be created by applying a wavelet transform to a signal that is L2 integrable and repeating the wavelet transform at varying scales.

In some cases, each filter family in the wavelet filter library 225 may correspond to a different respective entity, and satisfaction of a matching condition for a given filter family may indicate existence of the particular entity corresponding to that given filter family. For example, Filter Family A may correspond to a grasshopper and Filter Family B may correspond to a cricket.

For example, consider the sound file visualizations of a grasshopper and the cricket sounds depicted in FIG. 1A-1B, respectively. As described above, the grasshopper sound wave includes one, distinct wavelet (wavelet 1) and the cricket sound wave includes three, distinct wavelets (e.g., wavelet 2, wavelet 3, wavelet 4).

In this example, wavelet 1 is extracted from labeled grasshopper audio data to create a wavelet filter that substantially matches with wavelet 1; and wavelet 2, wavelet 3, and wavelet 4 are extracted from labeled cricket audio data to create three distinct wavelet filters. In some cases, this can include decoupling the distinct wavelets from the signals included in the labeled cricket audio data.

As such, an example wavelet filter library 225 can include Filter Family A, including wavelet filter 1 (representative of wavelet 1 associated with the grasshopper), and Filter Family B, including wavelet filter 2, wavelet filter 3, and wavelet filter 4 (representative of wavelet 2, wavelet 3, and wavelet 4, respectively, associated with the cricket).

Matching conditions for each filter family can depend on the particular algorithm used, including the permitted tolerances and confidence values for classifying a sound as a particular entity.

As illustrated in FIGS. 2A and 2B, method 250 includes receiving (252) sensor data; applying (254) a filter family to the sensor data; for each application of the filter family to the sensor data that satisfies a matching condition of the filter family, generating (256) an indication of an existence of the particular entity; and outputting (258) the indication of the existence of the particular entity. The sensor data received by controller 220 can include audio data collected from a microphone of sensor 210. The sensor data can include a signal (e.g., acoustic signal, vibrational signal, electromagnetic signal, or combinations thereof). In some cases, the received sensor data may be digitized sensor data generated from an analog sensor output.

The controller 220 can apply (254) one or more filter families from the wavelet filter library 225 to the received sensor data in a variety of ways. In some cases, the sensor data may be broken into segments (e.g., windows). The one or more filter families can be applied to one or more windows of the sensor data. To determine if a wavelet matches a window of the sensor data, techniques such as wavelet cross-correlation or matching pursuit may be used.

In some cases, the controller 220 may apply a single filter family to the sensor data. In some cases, the controller 220 may apply a plurality of filter families from the wavelet filter library 225 to the sensor data and may evaluate a respective matching condition for each applied filter family.

For each application of the filter family to the sensor data that satisfies a matching condition of the filter family, the controller 220 can generate (256) an indication of an existence of a particular entity listed in the entity catalog. As described herein, a wavelet filter can be considered to match a wavelet in the sensor data when the wavelet filter substantially matches the wavelet in the sensor data. For example, there can be a set minimum and maximum dilation of a signal in the sensor data (e.g., dilation tolerance). In some cases, the dilation tolerance can be wavelet specific.

In some cases, the generated indication may include a label identifying the particular entity corresponding to the filter family, a detection flag, a confidence value, a count value, a timestamp, or combinations thereof. In some cases, outputting the indication may include storing the indication, transmitting the indication to another device, presenting the indication at a user interface, or combinations thereof.

In some cases, the filter family satisfies a matching condition when a wavelet filter of the filter family matches wavelets in the sensor data two or more times. In some cases, the filter family satisfies a matching condition when a wavelet filter of the filter family matches two or more consecutive wavelets in the sensor data. For example, by identifying that a particular wavelet is repeated, it may provide higher certainty that the sensor data indicates the existence of a corresponding entity grasshopper. Using the non-limiting example of a wavelet filter family containing a wavelet based on the grasshopper signal shown in FIG. 1A, if the sensor data includes a sound made by a grasshopper, when Filter Family A (that includes wavelet 1 corresponding to the grasshopper) is applied, a matching condition will be met, and the controller 220 can generate (256) an indication of the existence of a grasshopper. The indication of the existence of a particular entity can be in any suitable form. As some non-limiting examples, an output of the matching operation may include a label and a certainty value, a binary value of detected or not detected, an accumulated value (e.g., indicating detection of a sufficient number of entities), etc. The indication of the existence of the particular entity can be output in any suitable manner or format as needed by the component receiving the output. For example, in some cases, the controller 220 can output (258) the indication of the existence of the particular entity to a user application and/or a data server (e.g., user application 320 and data server 330 as described with respect to FIG. 3A.)

In some cases, where a filter family includes a single wavelet filter, the matching condition may be satisfied when the single wavelet filter matches a wavelet in the sensor data one time, two times, or more than two times. In some cases, the matching condition may be satisfied when the single wavelet filter matches wavelets in the sensor data at two or more different times within one or more windows of the sensor data.

Notably, if Filter Family B (e.g., corresponding to cricket) was applied to the sensor data including the grasshopper audio signal, the application of Filter Family B would not satisfy matching conditions of the filter family.

In some cases, where the filter family includes a sequence of different wavelet filters (e.g., Filter Family B), the matching condition may be satisfied when at least one wavelet filter in the sequence matches a wavelet in the sensor data. For example, a matching condition of Filter Family B may be satisfied when at least wavelet filter 2 matches a wavelet in the sensor data, even if fewer than all of the wavelet filters in the sequence are matched.

In some cases, where the filter family includes a sequence of different wavelet filters, the matching condition may be satisfied when one wavelet filter in the sequence matches a wavelet in the sensor data. For example, a method may include applying a filter family having wavelet filter 2, wavelet filter 3, and wavelet filter 4, and satisfying the matching condition when wavelet filter 2 matches a wavelet in the sensor data.

In some cases, where the filter family includes a sequence of different wavelet filters (e.g., Filter Family B), the matching condition may be satisfied when the sequence of different wavelet filters matches a sequence of different wavelets in the sensor data. For example, a matching condition of Filter Family B may be met when wavelet filter 2, wavelet filter 3, and wavelet filter 4 respectively match wavelets in the sensor data in the order of 2, 3, and 4.

In some cases, a method may include applying a filter family that includes a sequence of different wavelet filters and determining that the matching condition is satisfied when the sequence of different wavelet filters matches a sequence of different wavelets in the sensor data. For example, the method may include determining that wavelet filter 2, wavelet filter 3, and wavelet filter 4 match corresponding wavelets in the sensor data in the same order.

In some cases, where a filter family includes a sequence of different wavelet filters, the sequence of different wavelet filters may, alone or in combination, indicate the particular entity corresponding to the filter family. In some cases, satisfying the matching condition based on the sequence may include matching fewer than all wavelet filters in the sequence. In some cases, satisfying the matching condition based on the sequence may include matching all wavelet filters in the sequence in an ordered arrangement in the sensor data.

In some cases, the sequence of wavelets in the sensor data are consecutive wavelets. In other words, the matching wavelets in the sensor data must occur not only in the same sequence as listed in the filter family, but also without intervening wavelets. For example, the sensor data must have signals that match wavelet filter 2, wavelet filter 3, and wavelet filter 4, that appear consecutively (e.g., no intervening wavelets).

In some cases, a method may include determining that the matching condition is satisfied when the sequence of different wavelets in the sensor data are consecutive wavelets. For example, the method may include determining that matching wavelets occur without intervening wavelets between successive matched wavelets in the sequence.

In some cases, the sequence of wavelets in the sensor data is non-consecutive wavelets. For example, a matching condition of Filter Family B may be met where wavelet filter 2, wavelet filter 3, and wavelet filter 4 each respectively match a wavelet in the sensor data and occur in that order, even if wavelets appear intermitted (e.g., intervening wavelets are ignored). For example, the sensor data can have wavelet filter 2, wavelet filter 6, wavelet filter 3, wavelet filter 7, and wavelet filter 4 and still satisfy a matching condition.

In some cases, a method may include determining that the matching condition is satisfied when the sequence of different wavelets in the sensor data are non-consecutive wavelets. For example, the method may include determining that matching wavelets occur in an ordered arrangement with one or more intervening wavelets between successive matched wavelets in the sequence.

FIG. 3A illustrates an example operating environment for a detection and identification system. Referring to FIG. 3A, the operating environment 300 can include a detection and identification (DI) system 340, a user application 320, and a data server 330. The DI system 340 can include a data acquisition (DAQ) system 305 and sensor(s) 310. User application 320 can be running on the data server 330, the DAQ system 305, or an independent computing device such as a mobile phone, laptop, tablet, or other computer.

In embodiments, the DI system 340 may be deployed with a plurality of sensors 310 coupled to the DAQ system 305. In some cases, the DAQ system 305 may aggregate sensor data from the plurality of sensors 310 and communicate detection results, sensor data, configuration data, or combinations thereof to the user application 320 and/or the data server 330.

FIG. 3B illustrates example system architecture for a data acquisition system. Referring to FIG. 3B, the DAQ system 305 can include a controller 350, a wavelet filter library 352, a sensor communication interface(s) 356, a communication module 358, and precision timing architecture 360. In some cases, the DAQ system 305 is contained within ruggedized housing (not shown). In some cases, the DAQ system 305 includes a battery and solar charging mechanism coupled to charge the battery (not shown).

In embodiments, the sensor communication interface(s) 356 may support communication between the DAQ system 305 and one or more sensors. In some cases, the sensor communication interface(s) 356 may receive sensor data from a sensor and may also provide device control signals, synchronization signals, power-related signals, or combinations thereof for operation of the sensor.

Referring to FIGS. 3A-3B, sensor 310 and DAQ system 305 can be physically connected to enable bidirectional communication between the sensor 310 and the DAQ system 305. The sensor 310, through a physical connection, can send data (e.g., sensor data) to the DAQ system 305 and receive device control commands (and optionally power) from the DAQ system 305.

The DAQ system 305 can receive sensor data at the sensor communication interface 356. In some cases, the sensor communication interface 356 can be a device driver.

Controller 350 can be, but is not limited to, a microprocessor. The controller 350 can perform method 250 as described with respect to FIGS. 2A-2B on sensor data received from sensor(s) 310. In some cases, the controller 350 can perform method 250 during idle processing time. In some cases, method 250 is implemented in software executed by controller 350. For example, an onboard software system can be provided that performs designer wavelet transforms to detect and speciate entities such as insects.

In some cases, certain functions of method 250 are implemented or accelerated in hardware. In some cases, controller can be used to perform operations of a neural network or other machine learning system and in some of such cases, models and/or weights may be stored as part of the wavelet filter library 352.

The controller 350 can receive data from the sensor communication interface 356. In some cases, the sensor communication interface 356 is a device driver. In some cases, the sensor communication interface 356 can amplify the sensor data received from the sensor 310 before sending the data to the controller 350.

The communication module 358 of the DAQ system 305 can be used to wirelessly communicate with a computing device executing the user application 320 and/or the data server 330. For example, the DAQ system 305 can output an indication of the existence of a particular entity to the computing device executing the user application 320 and/or the data server 330.

In some cases, the communication module 358 can use Wi-Fi, Bluetooth®, or other wireless communication protocol to communicate with the computing device executing the user application 320 and/or the data server 330.

In some cases, the DAQ system 305, via the communication module 358, can send and/or receive commands and/or data from the computing device executing the user application 320, and vice versa. The DAQ system 305, via the communication module 358, can send and/or receive commands and/or data from the data server 330.

In some cases, the DAQ system 305 can upload data to the data server 330.

The computing device executing the user application 320 can be communicatively coupled to the data server 330. In some cases, the computing device executing the user application 320 can upload data received from the DAQ system 305 to the data server 330. In some cases, the DAQ system 305 includes orchestration software which uploads files to a more centralized server for further analysis. In some cases, the data server 330 can send wavelet filter library updates to the user application 320. The computing device executing the user application 320 can send the wavelet filter library updates received from the data server 330 to the DAQ system 305.

In some cases, the communication module 358 may receive updates to the DAQ system 305 for the wavelet filter library 352 (e.g., add wavelet filters, remove wavelet filters, adjust matching parameters, adjust filter family designations, etc.) from the user application 320. For example, a user, via user application 320 may send updates to the DAQ system 305. In some cases, updates may be automatically triggered based on certain conditions.

Precision timing architecture 360 can be included for implementations where clock/timing is needed for ensuring proper communications between sensors and DAQ (as well as any other functionality relying on a clock).

In embodiments, the precision timing architecture 360 may provide timing reference information used by the controller 350, the sensor communication interface(s) 356, or both. In some cases, the timing reference information may support timestamping of sensor data, coordination of communications with one or more sensors, scheduled sampling, and/or other time-based operations.

FIG. 3C illustrates example system architecture for a sensor. Referring to FIG. 3C, a sensor 310 can include a sensor component 370, an analog to digital converter (ADC) 375 and a controller 380. In some cases, components of the sensor 310 are contained within ruggedized housing. The sensor component 370 can collect time domain data and can be a high-throughput sensor or a low-throughput sensor. The sensor component 370 can be a microphone, for example, a microelectromechanical systems (MEMS) microphone. In some cases, the sensor component 370 can have a flat-response sensitivity from 20-50,000 Hz.

In embodiments, the sensor component 370, the ADC 375, and the controller 380 may be arranged in a processing chain in which the sensor component 370 produces an analog electrical signal, the ADC 375 digitizes the analog electrical signal, and the controller 380 outputs corresponding digital sensor data to the DAQ system 305. In some cases, the controller 380 may also receive device control information and coordinate operation of the sensor component 370 and the ADC 375.

The sensor component 370 can convert sensor data to an electrical signal. The ADC 375 converts the electrical signal from the sensor component 370 to a digital signal for the controller 380.

The sensor 310 can provide the digital signal of the sensor data to the DAQ system 305 (e.g., via a physical connection).

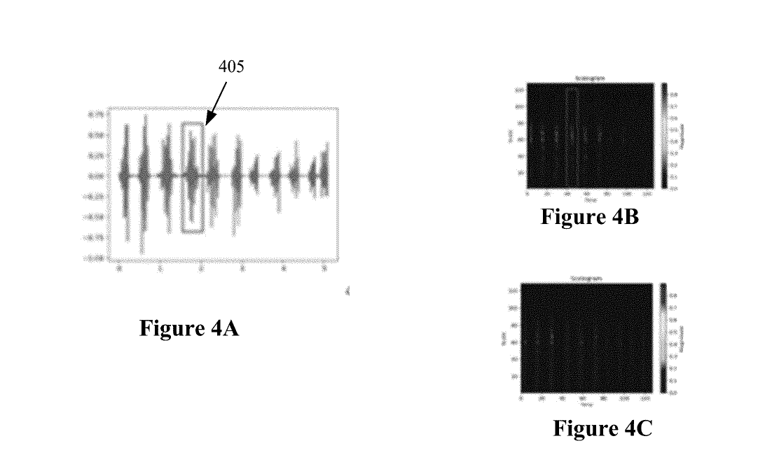

FIG. 4A illustrates a sound wave. FIG. 4B illustrates a scalogram depicting results of conventional wavelet analysis. FIG. 4C illustrates a scalogram depicting results of designer wavelet analysis (non-optimized). As will be apparent from FIGS. 4A-4C it is possible to generate designer wavelets that can give enhanced specificity and increased signal to noise ratio. That is, wavelets for the wavelet library used in the described systems can be designed to be mathematically similar to the signal they are intended to detect and are not required to be swept across all possible dilations, but rather only those near the wavelet. Additionally, several distinct wavelets can be used to correlate to a particular signal, increasing the specificity of the result.

For example, FIG. 4A depicts a time-domain representation of a signal with a selected region of interest 405. In some cases, the selected region of interest 405 may correspond to a portion of the signal used for extraction of one or more wavelets, generation of a wavelet filter, comparison with stored wavelet filters, or combinations thereof. For example, FIG. 4B and FIG. 4C depict analysis results for the signal of FIG. 4A, and the comparative plots may show that different wavelet-analysis approaches produce different localization, sensitivity, or resolution characteristics for the same underlying signal.

The designer wavelet analysis can be characterized by the application of more than one filter to a signal (e.g., filter family).

As can be seen by comparing FIG. 4B and FIG. 4C, there is appropriately a 10x sensitivity boost using the designed wavelet analysis. Further, the resolution is increased in using the designer wavelet analysis (vs. conventional wavelet analysis).

According to an example implementation, a set of algorithms can be provided for a DAQ system (or other processing system communicatively coupled to the DAQ system) that perform a wavelet transform on data with a specifically designed wavelet library to extract precise information from a signal. This signal can be, but is not limited to acoustic, vibrational, or electromagnetic signals. The wavelet library may be sufficient to speciate an animal based upon an acoustic or vibrational information or, alternatively, may serve as input for a machine-learning model that then classifies the data using the output of the wavelet transforms against the detected signal as input (though possibly not the exclusive input as it may then be correlated with other data such as location, temperature, time, and date).

A separate piece of software can be provided to extract wavelets from a labelled signal in an automated way that will then become part of the wavelet library that the DAQ uses to analyze information. The wavelet is then assigned a default upper and lower tolerance for analysis to determine the minimum and maximum dilation of the signal. This dilation tolerance may be adjusted if enough similar signals are available to give an accurate understanding of the range of time frames over which the analogous signal is likely to occur. Additionally, the algorithm can decouple distinct wavelets within a signal. Signals that appear simple to the human senses often consist of distinct components that are more easily disentangled by sensitive instrumentation and computational algorithms.

It should be understood that while insects have been described in the examples contained here, the described system is not limited to the speciation of animals but could also be used for things such as rapid identification and classification of noises in an urban environment, classification of air and ground vehicles at a distance, and potential detection and classification and any other unknown signal through wavelet transform.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A system, comprising:
a processor; and
a storage device, wherein the storage device comprises:
a wavelet filter library, wherein the wavelet filter library comprises at least one filter family corresponding to a particular entity; and
instructions stored in the storage device that when executed by the processor, direct the system to:
receive sensor data;
apply the filter family from the wavelet filter library to the sensor data;
for each application of the filter family to the sensor data that satisfies a matching condition of the filter family, generate an indication of an existence of the particular entity corresponding to that filter family; and
output the indication of the existence of the particular entity.

2. The system of claim 1, wherein the filter family comprises one wavelet filter that identifies the particular entity.

3. The system of claim 2, wherein the matching condition is satisfied when the one wavelet filter matches a wavelet in the sensor data.

4. The system of claim 2, wherein the matching condition is satisfied when the one wavelet filter matches wavelets in the sensor data two or more times.

5. The system of claim 1, wherein the filter family comprises a plurality of different wavelet filters that, alone or in combination, identify the particular entity.

6. The system of claim 5, wherein the matching condition is satisfied when at least one of the plurality of wavelet filters matches a wavelet in the sensor data.

7. The system of claim 1, wherein the filter family comprises a sequence of different wavelet filters that indicates the particular entity, wherein the matching condition is satisfied when the sequence of different wavelet filters matches a sequence of different wavelets in the sensor data.

8. The system of claim 7, wherein the sequence of different wavelets in the sensor data comprises consecutive wavelets.

9. The system of claim 7, wherein the sequence of different wavelets in the sensor data comprises non-consecutive wavelets.

10. The system of claim 1, further comprising at least one sensor from which the sensor data is received.

11. The system of claim 10, wherein the at least one sensor comprises a microphone.

12. The system of claim 11, wherein the microphone is a microelectromechanical systems (MEMS) microphone.

13. A method, comprising:
receiving sensor data;
applying a filter family to the sensor data;
for each application of the filter family to the sensor data that satisfies a matching condition of the filter family, generating an indication of an existence of a particular entity corresponding to that filter family; and
outputting the indication of the existence of the particular entity.

14. The method of claim 13, wherein the filter family comprises one wavelet filter that identifies the particular entity.

15. The method of claim 14, wherein the matching condition is satisfied when the one wavelet filter matches a wavelet in the sensor data.

16. The method of claim 14, wherein the matching condition is satisfied when the one wavelet filter matches wavelets in the sensor data two or more times.

17. The method of claim 13, wherein the filter family comprises a sequence of different wavelet filters that, alone or in combination, indicate the particular entity.

18. The method of claim 17, wherein the matching condition is satisfied when at least one wavelet filter in the sequence of different wavelet filters matches a wavelet in the sensor data.

19. The method of claim 17, wherein the matching condition is satisfied when the sequence of different wavelet filters matches a sequence of different wavelets in the sensor data.

20. The method of claim 19, wherein the matching condition is satisfied when the sequence of different wavelets in the sensor data comprises consecutive wavelets.
